(19) United States
(12) Patent Application Publication
(10) Pub. No.: US 2013/0170389 A1
(43) Pub. Date: Jul. 4, 2013

(54) NETWORK CONTROL SINGLE RADIO HANDOVER METHOD AND DEVICE BETWEEN HETEROGENEOUS WIRELESS NETWORKS

(71) Applicants: Jung-Hoon Jee, Daejeon-si (KR); Hong-Seok Jeon, Daejeon-si (KR); Yoon-Young An, Daejeon-si (KR); Chang-Min Park, Daejeon-si (KR)

(72) Inventors: Jung-Hoon Jee, Daejeon-si (KR); Hong-Seok Jeon, Daejeon-si (KR); Yoon-Young An, Daejeon-si (KR); Chang-Min Park, Daejeon-si (KR)

(73) Assignee: Electronics and Telecommunications Research Institute, Daejeon-si (KR)

(21) Appl. No.: 13/821,884

(22) PCT Filed: Sep. 5, 2011
(86) PCT No.: PCT/KR11/06547

§ 371 Date: Mar. 8, 2013

(30) Foreign Application Priority Data
Sep. 9, 2010 (KR) 10-2010-0088598
Jul. 1, 2011 (KR) 10-2011-0065659

(51) Int. Cl. H04W 36/20

(52) U.S. Cl. CPC H04W 36/20
USPC 370/252; 370/332

(57) ABSTRACT

Provided are a device and method for performing handover by detecting a state of another wireless network when only a wireless access interface for a current access network is activated in a mobile terminal. A handover controller performs communication between a mobile terminal performing a single radio handover and an information server managing access information for each wireless network. The handover controller obtains multi RAT access information used for accessing a network accessible at a current position of the mobile terminal. The handover controller obtains a network quality measurement result, which is measured using the multi RAT access information, from the mobile terminal, and determines a target network of the mobile terminal by using the network quality measurement result.

### TECHNICAL FIELD

The present invention relates to a method for reducing network access delay and packet loss when a mobile terminal moves across heterogeneous networks.

### BACKGROUND ART

In general, a service provider provides services such as Internet-based Multimedia Subsystem (IMS) to mobile terminals through various heterogeneous networks and various kinds of access technologies. Recently, many mobile terminals operate in a multi mode so that they can access a plurality of heterogeneous networks. In order to enable a mobile terminal to access a plurality of heterogeneous networks, a technique of providing a seamless service while reducing access delay upon handover between the heterogeneous networks is needed. For reducing access delay upon handover between heterogeneous networks, single radio handover has been proposed. The single radio handover is a method of performing handover between heterogeneous networks after enabling only an interface corresponding to a network which a mobile terminal currently accesses to be in a data receivable and transmittable state while enabling other access interfaces to be in a data receivable but non-transmittable state or in a data non-receivable and non-transmittable state.

As technology related to such single radio handover, Korean Laid-open Patent Application No. 10-2005-0023194 discloses a handover method for preventing packet loss in portable internet, laid-open on Mar. 9, 2005.

### Technical Problem

Accordingly, an apparatus and method for activating only an interface corresponding to a network to which a mobile terminal is currently connected, measuring the states of other wireless links, and then performing handover according to the results of the measurement are needed.

### Technical Solution

The present invention provides an apparatus and method for activating only an interface corresponding to a network to which a mobile terminal is currently connected, measuring the states of other wireless links, and then performing handover according to the results of the measurement.

Additional features of the invention will be set forth in the description which follows, and in part will be apparent from the description, or may be learned by practice of the invention.

### Advantageous Effects

Therefore, it is possible to avoid the situation where a plurality of wireless interfaces are simultaneously activated to thereby significantly reduce interference between the wireless interfaces, and to enable the qualities of multiple wireless links to be measured.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an example of a network system where network-controlled single radio handover is performed.

FIG. 2 illustrates a distribution example of wireless networks.

FIG. 3 is a flowchart illustrating an example of a network-controlled single radio handover method.

FIG. 4 is a diagram illustrating an example of a mobile terminal which performs network-controlled single radio handover.

FIG. 5 is a diagram illustrating an example of a handover controller which performs network-controlled single radio handover.

### BEST MODE

According to an aspect, there is provided a handover controller including: a communication unit configured to communicate with a mobile terminal that performs single radio handover and an information server that manages access information about each wireless network; and a handover deciding unit configured to acquire multi Radio Access Technology (RAT) access information from the information server through the communication unit, the multi RAT access information including access information about a network to which the mobile terminal is accessible at its current location, to acquire the result of quality measurement on the network from the mobile terminal, and to decide a target network to which the mobile terminal is to be handed over based on the result of the quality measurement.

According to another aspect, there is provided a method in which a handover controller operates, the handover controller connected to both an information server that manages access information about each wireless network and a mobile terminal that performs single radio handover, the method including: at the handover controller, acquiring multi Radio Access Technology (RAT) access information including access information about a network to which the mobile terminal is accessible at its current location; at the handover controller, transmitting a single radio scan request message to the mobile terminal, wherein the single radio scan request message includes the multi RAT access information and requests the mobile terminal to measure the quality of the network; at the handover controller, receiving the result of the quality measurement from the mobile terminal, wherein the result of the quality measurement has been obtained based on the multi RAT access information included in the single radio scan request; and deciding a target network based on the result of the quality measurement.

According to another aspect, there is provided a mobile terminal including: an interface unit configured to include a plurality of wireless interfaces through which the mobile terminal accesses a plurality of heterogeneous wireless networks, wherein the mobile terminal accesses a first network through a first interface which is one of the plurality of wireless interfaces; a network quality measuring unit configured to measure, if receiving a single radio scan request message including multi Radio Access Technology (RAT) access information that is used to access a wireless network adjacent to a current location of the mobile terminal from a handover controller through the first interface, the quality of at least one of the heterogeneous wireless networks using the multi RAT access information, and to transmit the result of the quality measurement to the handover controller through the first interface; and a handover performing unit configured to perform, if receiving, from the handover controller, a message that includes access information about a target network and instructs the mobile terminal to be handed over to the target network, handover to the target network in response to the message.

According to another aspect, there is provided a method in which a mobile terminal operates, the mobile terminal connected to a handover controller connected to an information server that manages access information for each wireless network, the method including: at the mobile terminal, receiving a single radio scan request message from the handover controller through a first interface which is one of a plurality of wireless interfaces, wherein the single radio scan request message includes multi Radio Access Technology (RAT) access information that is used to access a wireless network adjacent to a current location of the mobile terminal; at the mobile terminal, measuring the quality of the wireless network using the multi RAT access information; at the mobile terminal, transmitting the result of the quality measurement to the handover controller through the first interface; and at the mobile terminal, performing, if receiving a message including access information about a target network and instructing the mobile terminal to perform handover from the handover controller, handover to the target network.

According to another aspect, there is provided a method in which a system for performing network-controlled single radio handover operates, the system including a mobile terminal that performs single radio handover, an information server that manages access information about each network, and a handover controller connected to both the mobile terminal and the information server, the method including: at the information server, receiving a network access information request message from the handover controller and transmitting multi Radio Access Technology (RAT) access information to the handover controller in response to the network access information request message, wherein the multi RAT access information includes access information about a network to which the mobile terminal is accessible at its current location; at the handover controller, transmitting a single radio scan request message to the mobile terminal in response to the multi RAT access information, wherein the single radio scan request message includes the multi RAT access information and requests the mobile terminal to measure the quality of the network using the multi RAT access information; at the mobile terminal, measuring the quality of the network using the multi RAT access information and transmitting the result of the quality measurement to the handover controller; at the handover controller, deciding a target network based on the result of the quality measurement; and at the handover controller, transmitting a message for instructing the mobile terminal to be handed over to the target network to the mobile terminal.

It is to be understood that both the foregoing general description and the following detailed description are exemplary and explanatory and are intended to provide further explanation of the invention as claimed.

### MODE FOR INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

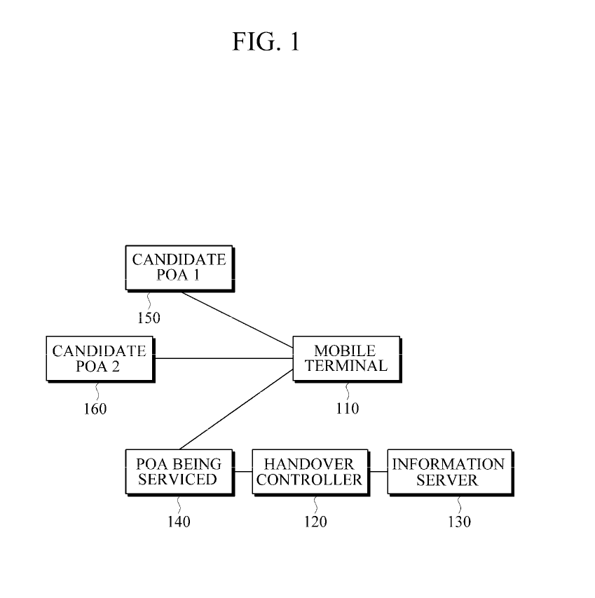

FIG. 1 is a diagram illustrating an example of a network system where network-controlled single radio handover is performed.

Referring to FIG. 1, the network system includes a mobile terminal 110, a handover controller 120, an information server 130, and a plurality of Point of Attachment (PoA) units 140, 150, and 160.

The mobile terminal 110 includes a multi-mode interface consisting of a plurality of wireless interfaces for accessing heterogeneous networks. For example, the mobile terminal 110 may include, as a multi-mode interface, various kinds of interfaces, such as a Worldwide interoperability for microwace access (WiMAX) network interface, a Wireless Fidelity (WiFi) network interface, a 3^{rd} Generation Partnership Project (3GPP) network interface, etc.

According to an example, the multi-mode interface may be defined as an interface type into which various kinds of heterogeneous network interfaces are integrated, or may be interpreted to include all or a part of various kinds of network interfaces individually attached to the mobile terminal 110. However, the multi-mode interface is not limited to these and may be implemented in more various forms. Also, the mobile terminal 110 may be a mobile phone, a smart phone, a personal computer, a laptop computer, etc.

The mobile terminal 110 performs handover based on single radio handover. Accordingly, the mobile terminal 110 enables only an interface corresponding to a network to which the mobile terminal 110 is currently connected to be in a data receivable and transmittable state, while enabling other interfaces to be in a data receivable but non-transmittable state or in a data non-receivable and non-transmittable state.

The handover controller 120 is connected to both the mobile terminal 110 and the information server 130. The handover controller 120 may be, as illustrated in FIG. 1, connected to the mobile terminal 110 through the PoA unit 140 of a network to which the mobile terminal 110 is currently connected, thereby performing message transmission/reception with the mobile terminal 110. Or, message transmission/reception between the handover controller 120 and the mobile terminal 110 may be performed through a Medium Access Control (MAC) protocol which is a network layer 2 or through an IP upper transmission protocol (for example, a User Datagram Protocol (UDP)), or the like.

The information server 120 stores wireless network access information about each of the heterogeneous networks. The wireless network access information may be stored in association with current location information of the mobile terminal 110. Here, the current location information of the mobile terminal 110 may be one of various kinds of information, such as Global Positioning System (GPS) information, wireless cell location information, PoA identifier information of a layer 2 (L2), etc., which can specify the location of the mobile terminal 110. The wireless network access information of the information server 130 may be configured as access information about heterogeneous wireless networks adjacent to a wireless network with respect to access information about the wireless network.

The information server 130 may transfer the wireless network access information about the heterogeneous networks to the handover controller 120 in response to a request from the handover controller 120. Also, the information server 130 may search for, when receiving a network access information request message including location information of the mobile terminal 110 from the handover controller 120, access information about all wireless networks which the mobile terminal 110 can access at its current location.

The plurality of PoA units 140, 150, and 160 may be WiFi Access Points (APs) or Cellular and WiMAX Base Stations (BSs) that provide wired/wireless link connections to the mobile terminal 110.

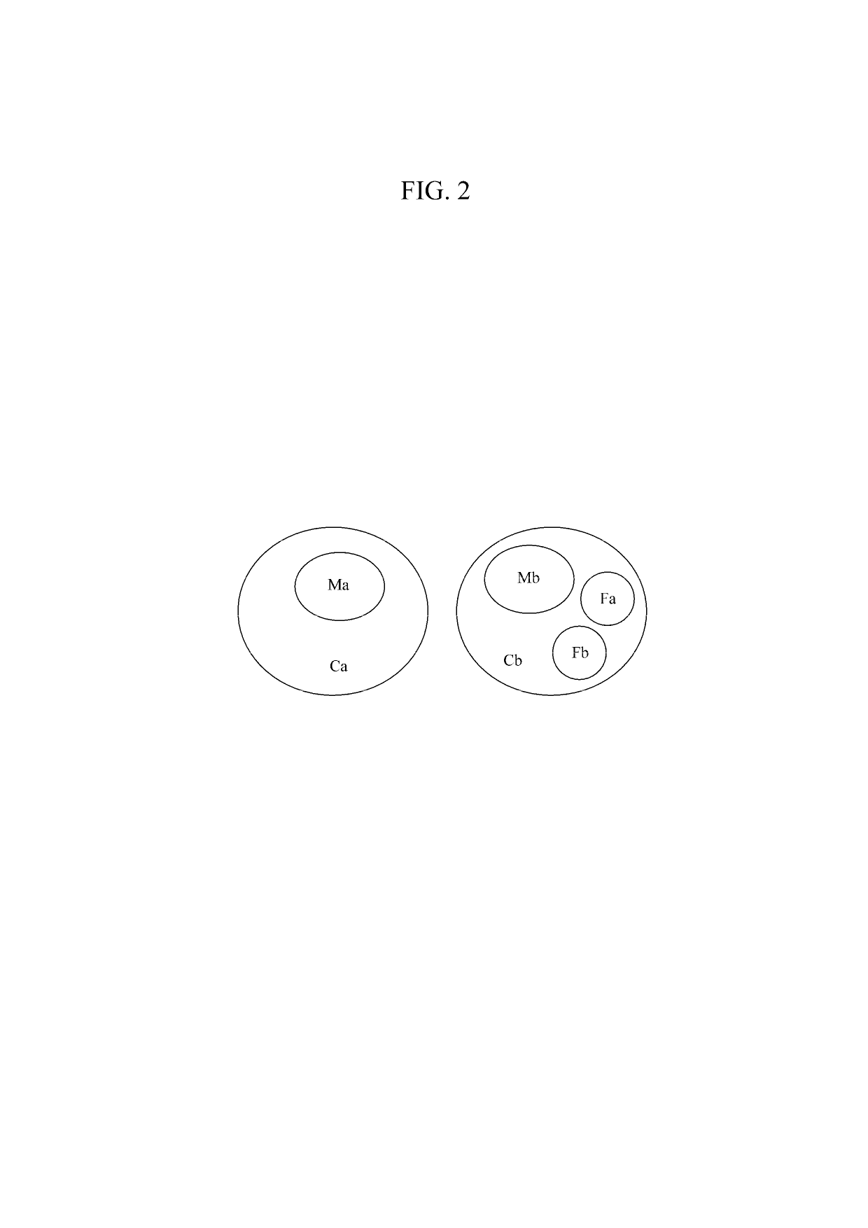

FIG. 2 illustrates a distribution example of wireless networks.

Table 1 shows an example of access information about heterogeneous wireless networks managed by the information server 130 (see FIG. 1) in association with FIG. 2. The access information about the heterogeneous wireless networks as shown in Table 1 is access information about heterogeneous wireless networks adjacent to a location indicated by 3GPP wireless cell information.

TABLE 1

| Broadband 3GPP Wireless | WiMAX Wireless | WiFi Wireless Access |
|---|---|---|
| Access Information | Information | Information |
| Ca | Ma | |
| Cb | Mb | Fa, Fb |

Referring to FIG. 1, FIG. 2 and Table 1, when the information server 130 receives a network access information request message including the fact that location information of the mobile terminal 110 is Ca, the information server 130 recognizes that the mobile terminal 110 can access both a broadband 3GPP network and a WiMAX network at the location Ca and transfers wireless network access information corresponding to Ca and Ma to the handover controller 120. If the information server 130 receives a network access information request message including the fact that location information of the mobile terminal 110 is Cb, the information server 130 recognizes that the mobile terminal 110 can access a broadband 3GPP network, a WiMAX network, and a Wifi network at the location Cb and transfers wireless network access information corresponding to Cb, Mb, Fa, and Fb to the handover controller 120.

Table 1 shows the case where access information about heterogeneous wireless networks adjacent to a specific location is established based on 3GPP wireless cell information, however, the access information about heterogeneous wireless networks may be established in various formats.

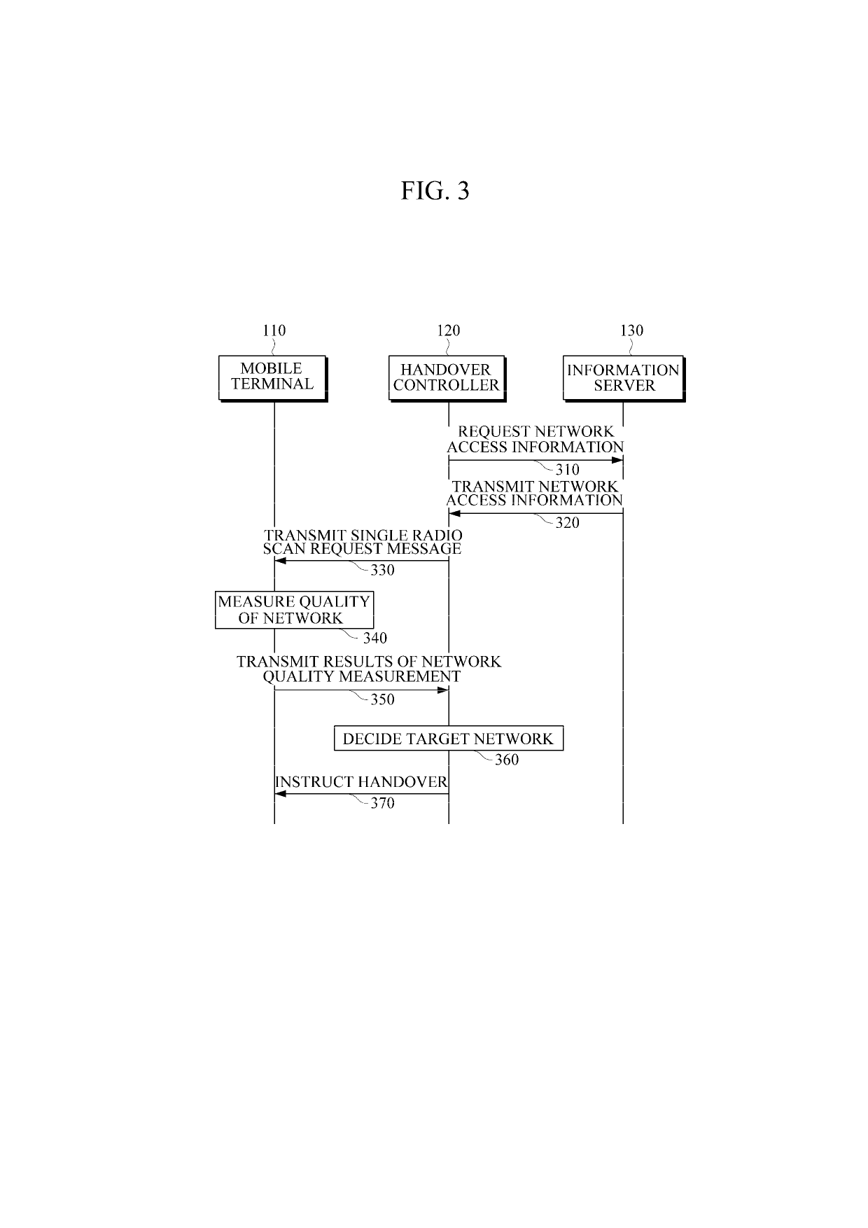

FIG. 3 is a flowchart illustrating an example of a network-controlled single radio handover method.

Referring to FIGS. 1 and 3, first, the handover controller 120 detects a current location of the mobile terminal 110 and requests the information server 130 to send wireless network access information about networks which the mobile terminal can access at its current location (310). At this time, the handover controller 120 may acquire location information of the mobile terminal 110 using various methods. For example, if the mobile terminal 110 moves from the PoA unit 140 to which the mobile terminal 100 is currently connected to the candidate PoA unit 150, the handover controller 120 may receive the fact that the mobile terminal 110 has moved from the PoA unit 140 to the candidate PoA unit 150, from the PoA unit 150 or from the mobile terminal 110. The location information of the mobile terminal 110 may be location information of a wireless cell to which the mobile terminal 110 is currently connected, identifier information of L2 PoA to which the mobile terminal 110 is currently connected, GPS information of the mobile terminal 110, etc.

The information server 130 may send a network access information response message to the handover controller 120 in response to the network access information request from the handover controller 120 (320). The network access information response message includes wireless network access information about all networks which the mobile terminal 110 can access except for the network to which the mobile terminal 110 is currently connected.

The access information about all networks which the mobile terminal 110 can access at its current location may be referred to as Multi Radio Access Technology (RAT) Access Information. The multi RAT access information includes information for accessing each wireless link. For example, the multi RAT access information may include a RAT type, a carrier frequency, an identifier of PoA that supports L2 connection, a preamble, a PHY profile ID, etc.

The RAT type represents a wireless network type (for example, WiMAX, WiFi, 3GPP). The carrier frequency represents information about a frequency that is used to access the corresponding wireless network. The PoA identifier that supports L2 connection represents an identifier of each PoA. The preamble represents information for synchronization with each PoA, and the PHY profile ID includes information for a physical connection to each PoA. The multi RAT access information is exemplary, and details configuring the multi RAT access information may depend on the kinds of wireless networks.

Then, the handover controller 120 may transmit a single radio scan request message to the mobile terminal 110 to request the mobile terminal 110 to measure the qualities of multiple wireless networks (330). The single radio scan request message includes the multi RAT access information received from the information server 130. The single radio scan request message may be transmitted through a wireless interface corresponding to the network to which the mobile terminal 110 is currently connected. Also, the single radio scan request message may be transmitted through an IP upper protocol or through a L2 frame of the network to which the mobile terminal 110 is currently connected.

Then, the mobile terminal 110 measures the quality of the wireless networks using the multi RAT access information received from the handover controller 120 (340). In this case, if the mobile terminal 110 can access a plurality of wireless networks, the mobile terminal 110 may measure the qualities of the multiple wireless networks. If a wireless interface that is used to access a network indicated by the multi RAT access information is power off, the mobile terminal 110 supplies power to the corresponding wireless interface to convert the state of the wireless interface into a data receivable state, and then analyzes a signal received through the wireless interface to thereby measure the quality of the network.

Then, the mobile terminal 110 transfers the result of the network quality measurement in the form of a single radio scan response message to the handover controller 120 (350).

Successively, the handover controller 120 decides a target network to which the mobile terminal 110 has to be handed over, based on the result of the network quality measurement (360). If receiving two or more results of the network quality measurement from the mobile terminal 110, the handover controller 120 may compare the network quality measurement results to each other to thereby decide a network having the highest quality as a target network.

Then, the handover controller 120 transmits a message including information about the target network and instructing that the mobile terminal 110 has to be handed over to the target network, to the mobile terminal 110 (370).

Thereafter, the mobile terminal 110 performs handover to the target network. Then, the mobile terminal 110 activates a wireless interface for accessing the target network and inactivates the wireless interface which the mobile terminal 110 has previously used. A procedure for performing handover may depend on the kind of a wireless network.

As such, the network-controlled single radio handover method obtains wireless connection information in association with the current location of a mobile terminal from an information server in advance before a handover controller on a network instructs the mobile terminal to perform handover, to thereby provide the wireless connection information to the mobile terminal when receiving a scan request from the mobile terminal, so that the mobile terminal can easily measure the qualities of multiple wireless networks.

According to an example, it is possible to avoid the situation where a plurality of wireless interfaces are simultaneously activated to thereby significantly reduce interference between the wireless interfaces, and to enable the qualities of multiple wireless links to be measured.

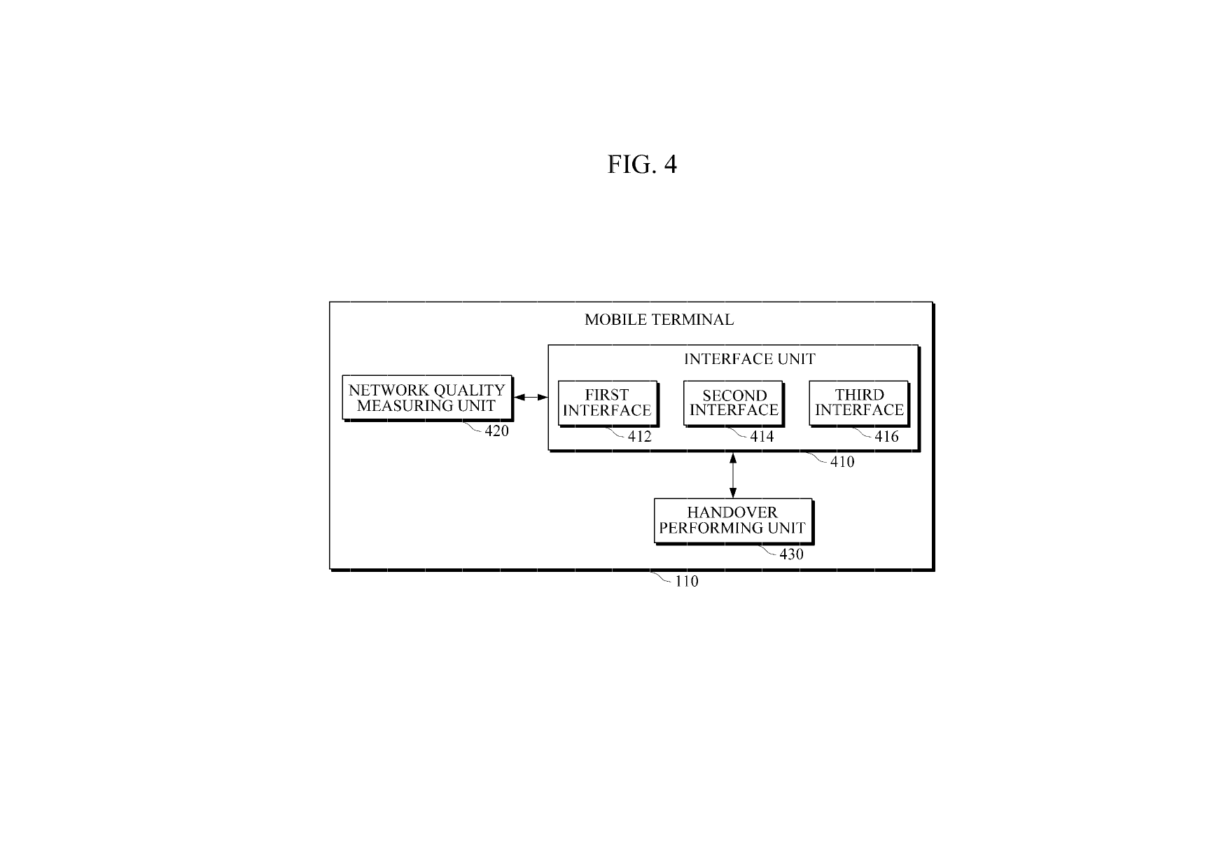

FIG. 4 is a diagram illustrating an example of the mobile terminal 110 (see FIG. 1) which performs network-controlled single radio handover.

The mobile terminal 110 may include an interface unit 410, a network quality measurement unit 420, and a handover performing unit 430. The interface unit 410 includes a plurality of wireless interfaces 412, 414, and 416. The wireless interfaces 412, 414, and 416 may be heterogeneous interfaces that are used to access heterogeneous wireless networks. FIG. 3 shows three interfaces, however, the kind and number of wireless interfaces included in the interface unit 410 are not limited.

The mobile terminal 110 may operate according to single radio handover. In this case, only one of the interfaces included in the interface unit 410 is activated so that the mobile terminal 110 operates in a data receivable and transmittable state with a network that the mobile terminal 110 can access through the corresponding interface, while the other wireless interfaces are maintained in a data receivable but non-transmittable state or in a data non-receivable and non-transmittable state. In the current example, for convenience of description, it is assumed the case where a first interface 412 is activated and the remaining interfaces 414 and 416 are inactivated.

If a single radio scan request message including multi RAT access information that is used to access a PoA unit adjacent to the current location of the mobile terminal 110 is received from the handover controller 120 (see FIG. 1) through the first interface 412, the network quality measuring unit 420 uses the multi RAT access information to measure the quality of a wireless network(s) which the mobile terminal 110 can access. Then, the network quality measuring unit 420 may check whether an interface for accessing the wireless network indicated by the multi RAT access information is operating. For example, if the second interface 414 is used to access the wireless network, the network quality measuring unit 420 may supply, if the second interface 414 is in a power-off state, power to the second interface 414 so that the second interface 414 operates.

Then, the network quality measuring unit 420 may analyze a signal received through the second interface 414 to thereby measure the quality of the corresponding wireless network. If interfaces for accessing wireless networks indicated by the multi RAT access information are the second interface 414 and a third interface 416, the network quality measuring unit 420 may analyze signals received through the second and third interfaces 414 and 416 to thereby measure the qualities of the networks. The network quality measuring unit 420 may measure the quality of each network using various parameters, such as signal intensity, signal quality, power intensity, etc.

The network quality measuring unit 420 transmits a response message including the result of the network quality measurement to the handover controller 120 through the first interface 412.

Then, the handover controller 120 decides a target network and transmits a handover instruction including access information about the target network to the mobile terminal 110 through the first interface 412. Then, the handover performing unit 430 performs handover according to the handover instruction. If an interface for accessing the target network is the second interface 414, the handover performing unit 430 controls the interface unit 410 to activate the second interface 414 and inactivate the remaining interfaces 412 and 416 so that signals are received and transmitted only through the second interface 414.

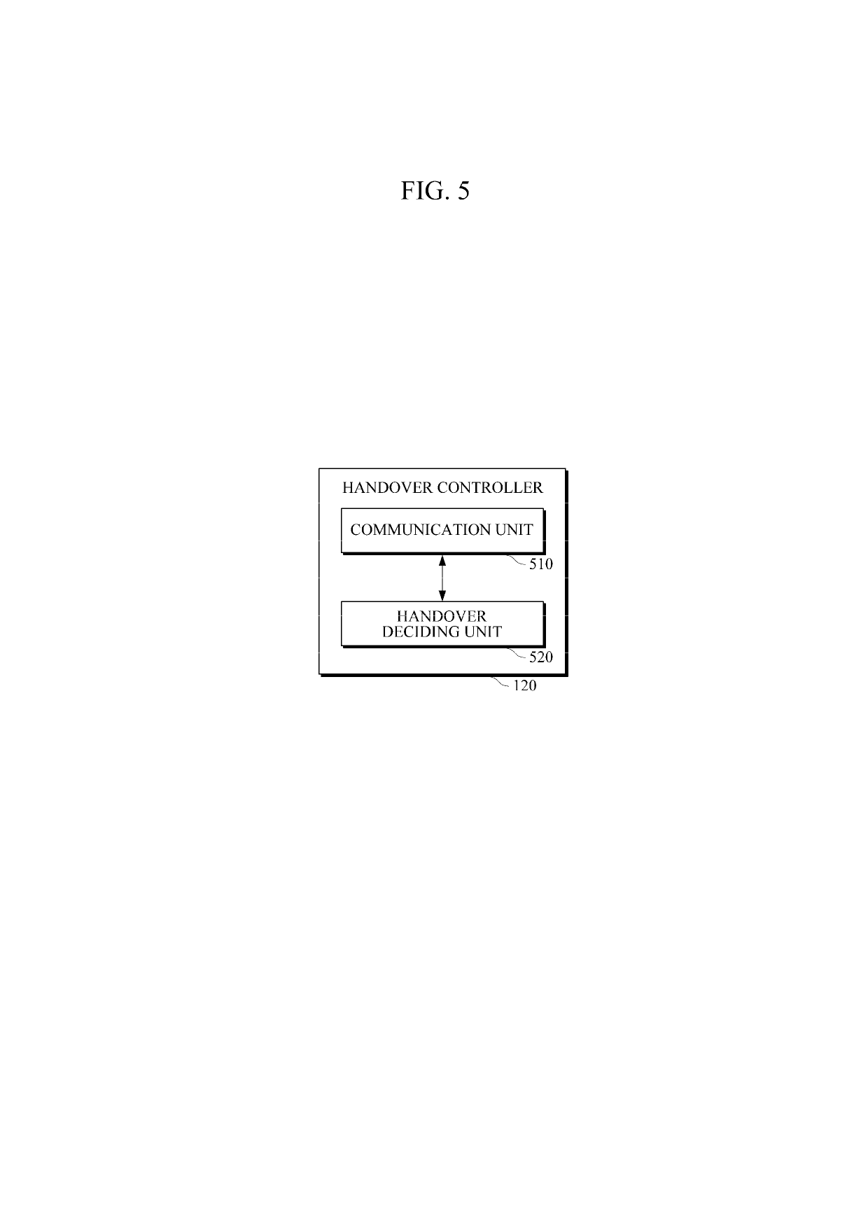

FIG. 5 is a diagram illustrating an example of the handover controller 120 (see FIG. 1) which performs network-controlled single radio handover.

The handover controller 120 may include a communication unit 510 and a handover deciding unit 520. The communication unit 510 includes a communication interface for communicating with the information server 130 (see FIG. 1) that integratedly manages the mobile terminal 110 and access information about each wireless network.

The handover deciding unit 520 recognizes the current location of the mobile terminal 110 (see FIG. 1).

The handover deciding unit 520 controls the communication unit 510 to request the information server 130 to send network access information that includes current location information of the mobile terminal 110 and that is used to access networks accessible by the mobile terminal 110 at the current location. Thereafter, the handover deciding unit 520 receives a network access information response message including multi RAT access information from the information server 130, wherein the multi RAT access information is used to access networks adjacent to the current location of the mobile terminal 110 through the communication unit 510. Then, the handover deciding unit 520 transmits a single radio scan request to the mobile terminal 110 through the communication unit 510, wherein the single radio scan request includes the multi RAT access information and causes the mobile terminal to measure the qualities of networks which the mobile terminal 110 can access using the multi RAT access information.

Then, the handover deciding unit 520 decides, when receiving a response message including the results of the network quality measurement from the mobile terminal 110, a target network to which the mobile terminal 110 has to be handed over based on the results of the network quality measurement. Successively, the handover deciding unit 520 transmits a message instructing handover to the target network to the mobile terminal 110 through the communication unit 510.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A handover controller comprising:
a communication unit configured to communicate with a mobile terminal that performs single radio handover and an information server that manages access information about each wireless network; and
a handover deciding unit configured to acquire multi Radio Access Technology (RAT) access information from the information server through the communication unit, the multi RAT access information including access information about a network to which the mobile terminal is accessible at its current location, to acquire the result of quality measurement on the network from the mobile terminal, and to decide a target network to which the mobile terminal is to be handed over based on the result of the quality measurement.

2. The handover controller of claim 1, wherein the handover deciding unit acquires information about the current location of the mobile terminal, and the information about the current location of the mobile terminal includes at least one of GPS information, wireless cell location information, and identifier information of a Point of Attachment (PoA) of a layer 2.

3. The handover controller of claim 1, wherein the handover deciding unit transmits a network access information request message for requesting the multi RAT access information including access information about the network to which the mobile terminal is accessible at its current location, to the information server through the communication unit.

4. The handover controller of claim 1, wherein the handover deciding unit transmits, if receiving the multi RAT access information from the information server, a single radio scan request message to the mobile terminal through the communication unit, wherein the single radio scan request message includes the multi RAT access information and requests the mobile terminal to measure the quality of the network.

5. A method in which a handover controller operates, the handover controller connected to both an information server that manages access information about each wireless network and a mobile terminal that performs single radio handover, the method comprising:
at the handover controller, acquiring multi Radio Access Technology (RAT) access information including access information about a network to which the mobile terminal is accessible at its current location;
at the handover controller, transmitting a single radio scan request message to the mobile terminal, wherein the single radio scan request message includes the multi RAT access information and requests the mobile terminal to measure the quality of the network;
at the handover controller, receiving the result of the quality measurement from the mobile terminal, wherein the result of the quality measurement has been obtained based on the multi RAT access information included in the single radio scan request; and
deciding a target network based on the result of the quality measurement.

6. The method of claim 5, before acquiring the multi RAT access information from the information server, further comprising:
at the handover controller, acquiring information about a current location of the mobile terminal; and
at the handover controller, transmitting a network access information request message to the information server, wherein the network access information request message is used to request the multi RAT access information including access information about a network to which the mobile terminal is accessible at the current location.

7. The method of claim 5, further comprising transmitting a message for instructing the mobile terminal to be handed over to the target network, to the mobile terminal.

8. A mobile terminal comprising:
an interface unit configured to include a plurality of wireless interfaces through which the mobile terminal accesses a plurality of heterogeneous wireless networks, wherein the mobile terminal accesses a first network through a first interface which is one of the plurality of wireless interfaces;
a network quality measuring unit configured to measure, if receiving a single radio scan request message including multi Radio Access Technology (RAT) access information that is used to access a wireless network adjacent to a current location of the mobile terminal from a handover controller through the first interface, the quality of at least one of the heterogeneous wireless networks using the multi RAT access information, and to transmit the result of the quality measurement to the handover controller through the first interface; and
a handover performing unit configured to perform, if receiving, from the handover controller, a message that includes access information about a target network and instructs the mobile terminal to be handed over to the target network, handovers to the target network in response to the message.

9. The mobile terminal of claim 8, wherein the network quality measuring unit supplies, if a second interface for accessing a network indicated by the multi RAT access information among the plurality of wireless interfaces is power off, power to the second interface so that the mobile terminal receives a signal from the network through the second interface.

10. The mobile terminal of claim 8, wherein if the mobile terminal is able to access the target network through a second interface which is one of the plurality of wireless interfaces, the handover performing unit activates the second interface and inactivates the remaining interfaces of the plurality of wireless interfaces so that signals are transmitted and received through the second interface.

11. A method in which a mobile terminal operates, the mobile terminal connected to a handover controller connected to an information server that manages access information for each wireless network, the method comprising:
at the mobile terminal, receiving a single radio scan request message from the handover controller through a first interface which is one of a plurality of wireless interfaces, wherein the single radio scan request message includes multi Radio Access Technology (RAT) access information that is used to access a wireless network adjacent to a current location of the mobile terminal;
at the mobile terminal, measuring the quality of the wireless network using the multi RAT access information;
at the mobile terminal, transmitting the result of the quality measurement to the handover controller through the first interface; and
at the mobile terminal, performing, if receiving a message including access information about a target network and instructing the mobile terminal to perform handover from the handover controller, handover to the target network.

12. The method of claim 11, wherein the measuring of the quality of the wireless network using the multi RAT access information further comprises supplying, if a second interface for accessing a network indicated by the multi RAT access information among the plurality of wireless interfaces is power off, power to the second interface so that the mobile terminal receives a signal from the network through the second interface.

13. A method in which a system for performing network-controlled single radio handover operates, the system including a mobile terminal that performs single radio handover, an information server that manages access information about each network, and a handover controller connected to both the mobile terminal and the information server, the method comprising:
at the information server, receiving a network access information request message from the handover controller and transmitting multi Radio Access Technology (RAT) access information to the handover controller in response to the network access information request message, wherein the multi RAT access information includes access information about a network to which the mobile terminal is accessible at its current location;
at the handover controller, transmitting a single radio scan request message to the mobile terminal in response to the multi RAT access information, wherein the single radio scan request message includes the multi RAT access information and requests the mobile terminal to measure the quality of the network using the multi RAT access information;
at the mobile terminal, measuring the quality of the network using the multi RAT access information and transmitting the result of the quality measurement to the handover controller;
at the handover controller, deciding a target network based on the result of the quality measurement; and
at the handover controller, transmitting a message for instructing the mobile terminal to be handed over to the target network to the mobile terminal.

14. The method of claim 13, wherein the access information for each wireless network is access information of heterogeneous wireless networks adjacent to a wireless network based on access information of the wireless network.

15. The method of claim 13, wherein the multi RAT access information includes at least one of a RAT type, a carrier frequency, an identifier of a PoA that supports L2 connection, a preamble, and a PHY profile ID.

16. The method of claim 13, wherein the mobile terminal performs, if receiving a message that includes access information about the target network and instructs the mobile terminal to be handed over to the target network from the handover controller, single radio handover to the target network in response to the message.

17. The method of claim 13, wherein the measuring of the quality of the network using the multi RAT access information further comprises supplying, if an interface for accessing the network among a plurality of interfaces included in the mobile terminal is power off, power to the interface so that the mobile terminal receives a signal from the network through the interface.
